(19) United States
(12) Patent Application Publication
(10) Pub. No.: US 2011/0003125 A1
(43) Pub. Date: Jan. 6, 2011

(54) GLASS PRODUCT AND A METHOD FOR MANUFACTURING A GLASS PRODUCT

(75) Inventors: Markku Rajala, Vantaa (FI); Pekka Soininen, Helsinki (FI); Sami Sneck, Vantaa (FI)

Correspondence Address: MERCHANT & GOULD PC, P.O. BOX 2903, MINNEAPOLIS, MN, 55402-0903, US

(73) Assignee: BENQ OY, Vantaa (FI)

(21) Appl. No.: 12/809,411

(22) PCT Filed: Dec. 19, 2008
(86) PCT No.: PCT/FI2008/050773

§ 371 Date: Sep. 20, 2010

(30) Foreign Application Priority Data
Dec. 19, 2007 (FI) 20070991

(51) Int. Cl. C03C 17/36; B32B 15/04; B32B 17/06; G02B 5/08; B05D 1/36

(52) U.S. Cl. 428/213; 428/433; 359/883; 427/404

(57) ABSTRACT

A glass product of the present invention (1) comprises a glass substrate (2), a reflective metal layer (3) deposited on the glass substrate, and a passivation layer (4) deposited on the reflective metal layer. According to the present invention, the passivation layer (4) is deposited using an Atomic Layer Deposition (ALD) process.

### FIELD OF THE INVENTION

The present invention relates to glass products and manufacturing thereof, the glass products comprising at least a glass substrate, a reflective metal layer deposited on the substrate and a passivation material protection layer coating the metal layer. Glass products according to the present invention can be used e.g. as low emissivity window glasses, mirrors, and optical or photonics components.

### BACKGROUND OF THE INVENTION

A glass substrate coated by a reflective metal layer has numerous important applications. One common example is the so called low-e glass, i.e. a low emissivity window glass reflecting thermal radiation from a room backwards, thereby decreasing heat escaping from the building. Other well known examples are mirrors and optical components.

The reflective metal layer should be highly reflective and as resistant as possible against corrosion when exposed to the air. A good material choice from the reflectivity point of view is silver. However, silver usually tarnishes rapidly in the atmosphere, particularly upon the presence of sulfur. Particularly, different substances present in the industrial environments are effective sources for silver tarnishing. In tarnishing, sulfides, oxides, and carbides are formed on the surface of the silver. Naturally, tarnishing deteriorates the optical properties, like reflectivity, of the silver.

A metal-coated glass product, like a plate glass, is usually coated using a sputtering process. Due to said tendency of the metal surface to tarnish, a metal oxide layer is often sputtered on the metal layer in order to protect the surface of the metal. When sputtering the metal oxide, one important aspect is to ensure that the reactive, oxygen-rich sputtering atmosphere itself do not cause tarnishing of the silver surface. U.S. Pat. No. 4,421,622 discloses a method employing feeding, into the sputtering chamber, a small amount of hydrogen in order to prevent the silver tarnishing. As an alternative way, the publication also discloses preventing the tarnishing by sputtering first, with a high deposition rate, a first metal oxide layer with a thickness of about 100 Å, after which the rest of the oxide layer is sputtered using a normal, slower deposition rate. U.S. Pat. No. 4,462,883 instead, discloses sputtering on the silver, before the metal oxide, first a layer of some other metal. Similar principle utilizing deposition of an intermediate metal layer before sputtering the metal oxide is disclosed also in FI 90655 C.

In the case of the low emissivity window and other applications where light transmission through the glass product is important, it is desirable, from the glass product's optical properties point of view, to have the refractive index of the metal oxide layer as high as possible, preferably higher than 2. A high refractive index decreases the reflectivity of the visible light wavelengths from the metal layer, thus improving the transparency of the glass product. Naturally, at the same time the light absorption in the metal oxide layer should be as low as possible.

In order to enable a long lifetime of the glass product exposed to changing atmospheric conditions, the adhesion of the metal oxide to the reflective metal layer should be as strong as possible. In addition, the metal oxide layer should not include pores or gaps through which the metal layer could become exposed to corrosion. U.S. Pat. No. 4,716,086 discloses a coating protecting a reflective metal surface, the coating consisting of a non-reflective metal oxide layer deposited on the metal layer and a protecting metal oxide film having a thickness of 10-50 Å deposited on the non-reflective metal oxide layer. The metal oxide layers are produced by sputtering.

There are several problems associated with the sputtered metal oxide layers. For example, the thickness variations of the layers are usually high. As an example, U.S. Pat. No. 6,541,133 B1 discloses a sputtered metal oxide layer as a protective coating on a metal surface, the metal oxide layer including zinc and tin oxide doped with at least some of the following elements: Al, Ga, In, B, Y, La, Ge, Si, P, As, Sb, Bi, Ce, Ti, Zr, Nb, and Ta. The thickness of the metal oxide layer varies between 2 and 6 nm. Also in general, the thickness variation of a sputtered metal oxide layer is typically several percentage units in both directions around the average value. One example of the thickness variations in sputtered layers is published by Juan et al. in “High Reflectivity micromirrors fabricated by high aspect ratio Si sidewalls”, Journal of Vacuum Science & technology B: microelectronics and Nanometer Structures, vol. 15, issue 6, pages 2661-2665. The reported variation was 6%. In addition, it is clear that the thickness variation increases when the profile of the surface to be coated deviates from a planar one. Due to the “line-of-sight” nature of the sputtering process, in an object with a complex shape some areas of the object can even remain uncoated and thus open to corrosion.

Uniformity requirement of the protective metal oxide layer is particularly important in applications requiring high optical quality of the surfaces. One example of this type is telescope mirrors. In this kind of products, with the prior art sputtering processes, the magnetron used in the sputtering has to be moved and rotated in an accurately determined way in order to produce a layer with a sufficient thickness uniformity. Nonetheless, the resulting relative thickness variation can be, for example, +/−5%. For a layer with a nominal thickness of 20 nm, this makes an absolute thickness variation of +/−1 nm. Results of this type were reported e.g. by Boccas et al. In “Protected-silver coatings for the 8-m Gemini telescope mirrors”, Thin Solid Films, vol. 502, 2006, pages 275-280.

Sputtering is a physical vapor deposition (PVD) method, which means that there is no chemical bonding between the sputtered layer and the substrate on which it is deposited. Thus, the bond between the layers is not very strong and the layer interface structure can have defects, which in optical devices can deteriorate the optical performance of the structure.

Hence, it is clear that there is a need for glass products and a manufacturing method thereof, the glass products having a reflective metal layer on it, the surface of the metal layer being protected by a continuous and conformal metal oxide coating preferably tightly adhered to the metal layer and having a uniform thickness. Glass products of said type can be used, for example, in low emissivity windows, different kinds of mirrors like telescope mirrors, lenses and other components of optical instruments, and photonics components.

### PURPOSE OF THE INVENTION

The purpose of the present invention is to respond to said need by providing a glass product of said type and a manufacturing method to produce such glass products.

### SUMMARY OF THE INVENTION

The glass product of the present invention is characterized by what is presented in claim 1. It comprises a glass substrate, a reflective metal layer deposited on the glass substrate, and a passivation layer deposited on the metal layer. Glass substrate means a solid glass object, the form, size, and other properties being determined by the intended application of the final glass product. Reflective means here a surface reflecting, in at least one wavelength range, at least partially the incident electromagnetic radiation. As is explained below, the actual reflection performance is dependent on the actual embodiment of the glass product. The reflective metal layer is usually, but not necessarily, deposited directly on the glass substrate. In a preferred embodiment of the present invention, the passivation layer is deposited directly on the surface of the reflective metal layer.

According to the present invention, the passivation layer is deposited using an Atomic Layer Deposition (ALD) process. ALD is known as a thin film technology enabling accurate and well controlled production of thin film coatings with nanometer-scaled thicknesses. ALD is sometimes called also Atomic Layer Coatings ALC, or Atomic Layer Epitaxy ALE. In an ALD process, the substrate is alternately exposed to at least two precursors, one precursor at a time, to form on the substrate a coating by alternately repeating essentially self-limiting surface reactions between the surface of the substrate (on the later stages, naturally, the surface of the already formed coating layer on the substrate) and the precursors. As a result, the deposited material is “grown” on the substrate molecule layer by molecule layer.

In general, coating layers deposited by ALD have several advantageous features. Firstly, the molecule layer by molecule layer type coating formation means very well controllable layer thickness. Secondly, due to the surface controlled reactions in the deposition process, the coating is deposited uniformly through the entire surface of the substrate regardless of the substrate geometry. Thirdly, due to attachment of the source material molecules on the substrate by chemisorption, the coating is adhered to the substrate by chemical bonds between the coating and the substrate molecules, making the attachment of the coating to the substrate very strong. In the glass product of the present invention, the advantages achievable by a passivation layer produced by ALD thus include:
low passivation layer thickness variation;
good conformity between the metal oxide layer and the reflective metal layer also in complex shaped glass products; and
in the preferred embodiment with the passivation layer deposited directly on the reflective metal surface, strong attachment of the protective passivation layer to the reflective metal layer.

The passivation layer thickness variation can be e.g. less than +/−2%, even as low as +/−0.5% of the average thickness. Consequently, the distortions, caused by the passivation layer thickness variations, in the optical properties of the glass product can be kept negligible. As one important effect of this, the glass product can have an optical performance which is substantially uniform through the wavelength range of interest. Small relative thickness variation also enables an absolute passivation layer thickness higher than that of a sputtered layer. This is, if there is a maximum value for the acceptable absolute metal oxide thickness variation, the total layer thickness can be higher in the case of a lower relative variation. Higher protective coating thickness means, naturally, better protectiveness against corrosive material diffusion and chemical reactions.

The conformal coverage of the passivation layer produced by ALD enables application of the basic principle of the present invention also in glass products with a complex geometry. In a complex shaped glass product, the uniformity of the passivation layer thickness also ensures an effective material consumption without any unnecessary excess of the metal oxide due to areas with a layer thickness over the required one.

Said strong attachment of the protective passivation layer coating the reflective metal layer decreases the peeling probability of the passivation material.

Thus, to summarize, the present invention provides great advantages with comparison to the prior art technology suffering from high thickness variation, poor conformity, and loose attachment of the passivation layer.

Due to its extremely high reflectivity, one preferred material for the reflective metal layer is silver.

In one preferred embodiment, the passivation layer comprises metal oxide which, for it's part, preferably comprises oxide of at least one of the following metals: Al, Ti, Zr, Nb, Zn, Si, Ta, Hf. Metal oxides, particularly the above listed ones, are suitable for ALD process and they act as effective diffusion and chemical barrier. In addition, they can be deposited directly on the reflective metal layer of e.g. silver. Another good material choice for the passivation layer is zinc sulfide ZnS. Due to it's common utilization in the field of optics, zinc sulfide is particularly suitable for passivation layer in optical components.

The total thickness of the passivation material coating the reflective metal layer is preferably less than about 200 nm, more preferably less than about 100 nm, most preferably less than about 50 nm. The total thickness of the passivation material refers to a possibility of having on the reflective metal layer several superimposed passivation layers one on another. The limit of the total thickness comes from a target to minimize the effect of the passivation material to the optical performance of the glass product. Already a thickness less than 200 nm is usually a rather good choice. Less than 100 nm prevents mostly the interference-induced color effects. Minimizing also the absorption in the passivation layer is most efficiently achieved with a thickness less than 50 nm. Thus, although the protectivity point of view would suggest as thick passivation layer as possible, the optical performance point of view, due e.g. the interference effects, requires limiting the thickness.

In one preferred embodiment of the present invention, the glass product of the present invention is a flat glass product for a low emissivity window. In this application, the glass substrate is a sheet of flat glass. The reflective metal layer in a low emissivity window is preferably adjusted to be highly reflective in the infrared wavelengths in order to efficiently prevent the thermal radiation escaping from the indoors. On the other hand, the reflectivity and the absorption disturbing the window transparency in the visible wavelengths should be as low as possible.

On the other hand, in another preferable embodiment, the glass product is a mirror. In a mirror, naturally, the purpose of the reflective metal layer is to reflect all the incident radiation in the wavelength range of interest with as good efficiency as possible. The good protection of the reflective metal layer against corrosion by the strongly attached, conformal metal oxide passivation having a uniform thickness enables very long lifetimes for the mirrors in different conditions. The mirror can be a plane mirror or e.g. a telescope mirror with a concave reflecting surface geometry. Particularly in the case of possibly very large telescope mirrors, the present invention provides great benefits also from the manufacturing and process equipment point of view. In the case of such large, complex-shaped surfaces, depositing the passivation by a line-of-sight process, like sputtering, is far more challenging than when ALD is used.

The advantages of the uniform thickness and the conformity of the passivation layer are perhaps most obvious in an embodiment where the glass product is an optical component, e.g. a lens, for an optical system. In an optical component, the purpose of the reflective metal surface usually is to reflect infrared portion of the incident radiation. In optical components, naturally, the optical properties are crucial. Often already very small variations e.g. in the passivation layer thickness can cause harmful effects in the optical performance. From this point of view, the present invention provides great benefits. The possibly complex-shaped glass substrate of a mirror or an optical component can be produced, for example, by molding and/or grinding.

In addition to the optical components mentioned above, the glass product of the present invention can also be a photonics component. Satisfactory operation of a photonics component often necessitates very accurate passivation layer geometry. Thus, the present invention can result in significant improvements also in such components.

Except for the exclusively alternate glass product types of claims 8 to 10, one or more of the preferable features determined above can be present in a glass product according to the present invention in any combination.

The method of the present invention is characterized by what is presented in claim 11. The method for manufacturing a glass product comprises depositing a reflective metal layer on a glass substrate, and depositing a passivation layer on the metal layer. The reflective metal layer is usually, but not necessarily, deposited directly on the surface of the glass substrate using, for example, sputtering.

According to the present invention, the passivation layer is deposited, preferably directly on the reflective metal surface, using an atomic layer deposition (ALD) process, the core principles and properties of which as well as the advantages achieved by it in the metal oxide deposition being described in the above.

The temperature used in the ALD process depends on the material to be deposited. In general, it is often desired to use rather high temperatures. However, in the present invention, in the case of depositing metal oxide as the passivation layer material, it is preferable to use a temperature where the reflective metal layer surface oxidation remains as low as possible. Thus, in a preferred embodiment of the present invention, the passivation layer is deposited in a temperature in the range of 30 to 400° C., more preferably 80 to 300° C., most preferably 100 to 150° C.

The precursor for the metal oxide deposition depends on the metal oxide. For example, for aluminum oxide Al₂O₃, trimethyl aluminum (CH₃)₃Al can be used. A preferable choice for the oxygen source is water H₂O. Using water enables the oxidation of the reflective metal layer surface during the deposition process to remain low. Other suitable oxygen sources are ozone O₃ and oxygen plasma.

On the other hand, in another preferred embodiment of the present invention, the passivation layer deposition comprises depositing zinc sulfide.

### SHORT DESCRIPTION OF THE DRAWINGS

In the following, the present invention is described in more detail by means of the accompanying figures.

FIG. 1 is a schematic presentation of a glass product according to the present invention.

FIG. 2 illustrates the passivation material deposition according to the present invention.

### DETAILED DESCRIPTION OF THE INVENTION

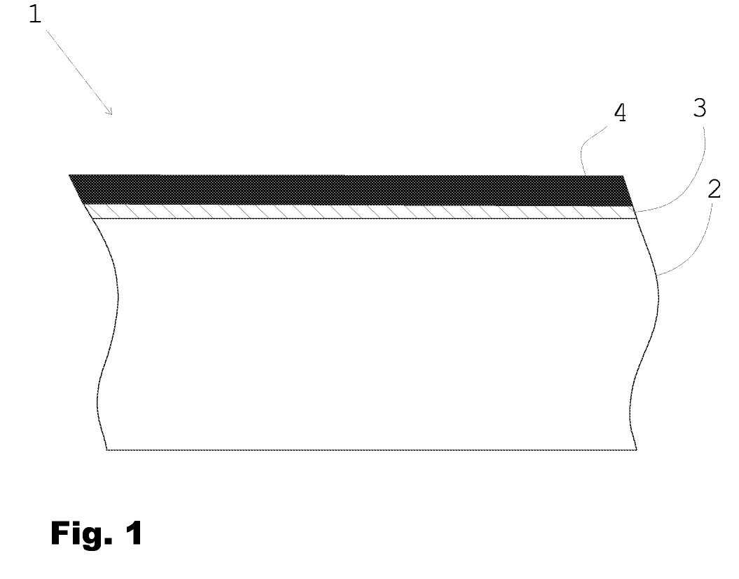

The glass product 1 of FIG. 1 can be, for example, a glass sheet for a low emissivity window. The glass product comprises a glass substrate 2, a silver layer 3 attached to the glass substrate, and an aluminum oxide layer 4 deposited by ALD on the reflective silver layer. Between the glass substrate 2 and the reflective silver layer 3 there can be an adhesion layer or some other coating layer. The purpose of the silver layer 3 is to reflect at least part of the incident radiation. In the case of a low emissivity window, this means decreasing heat losses from a building by reflecting thermal radiation from the indoors backwards. On the other hand, in a window glass embodiment, the silver layer 3 thickness should be thin enough not to significantly disturb the visible light transmission through the window. The aluminum oxide layer 4 acts as a protection against tarnishing of the silver due to different kinds of corrosion processes. In order to minimize the effect of the aluminum oxide layer 4 on the optical performance of the glass product 1, the aluminum oxide layer thickness is preferably less than 50 nm.

Due to the ALD process, the aluminum oxide layer 4 has a very uniform thickness throughout the coated silver surface. The thickness variation is typically below +/−2% of the average metal oxide thickness. Another advantageous feature thanks to the ALD process is that the aluminum oxide layer 4 is adhered to the silver surface very strongly by chemical bonds. This effectively decreases the probability of the metal oxide to peel off, resulting in a long lifetime and reliable operation of the glass product 1. As a third important characteristic of the glass product, though not particularly illustrated by the flat geometry of the example in FIG. 1, the aluminum oxide layer 4 covers the reflective silver layer 3 of the glass product with a good conformity, i.e. the aluminum oxide layer 4 follows the reflective silver layer 3 surface profile.

The key principles of the present invention allow the basic structure shown in FIG. 1 to be modified in many ways. Firstly, the materials can be changed. The silver can be replaced, in principle, by any sufficiently reflective metal. Similarly, aluminum oxide is just one, though a preferred one, example of suitable metal oxides for passivating the reflective metal surface. Passivation material can be also some other than a metal oxide, e.g. zinc sulfide. Further, the reflective metal layer can consist of several sublayers. On the other hand, also the passivation material protection coating the silver can comprise more than one layer and even different materials. Important is, however, that at least the lowermost layer is deposited on the reflective metal surface by ALD, and that the total thickness of the passivation material should not exceed 200 nm in order to not disturb the optical properties of the glass product. For example, in many applications it is desired to have a passivation layer which is substantially invisible for a human eye.

Naturally, a low emissivity window is just one preferred example of the embodiments of the present invention. Other possible applications for the glass product having the basic structure similar to that shown in FIG. 1 are different kinds of mirrors, e.g. telescope mirrors, and optical components, e.g. lenses, for optical systems. Naturally, the details like the silver layer thickness and the glass substrate geometry vary according to the application at issue.

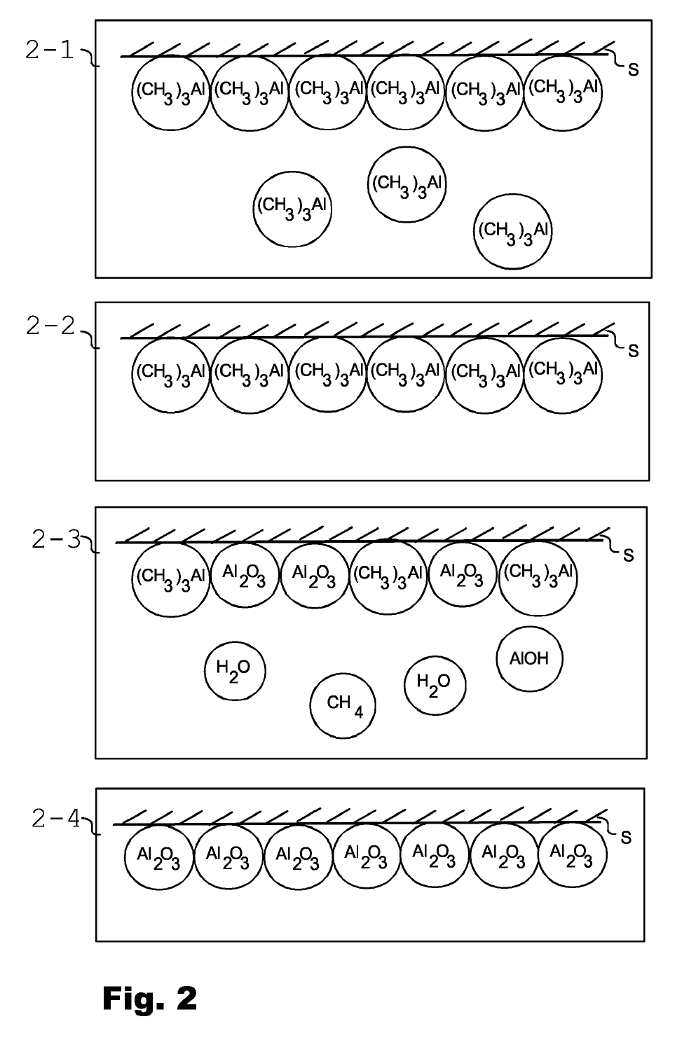

In the process illustrated in FIG. 2, a reflective silver layer on a glass substrate is coated by superimposing on it molecule layers of aluminum oxide Al₂O₃ by an ALD process using trimethyl aluminum (CH₃)₃Al as a precursor and water H₂O as an oxygen source.

In step 2-1, the surface S of the silver layer is exposed to gas comprising trimethyl aluminum. This results in a single molecule layer of trimethyl aluminum to be formed on the silver surface S. In the layer formation, the molecules are attached to the surface by chemisorption, the layer formation process being self-limiting and continuing until the layer covers the entire surface S. In step 2-2, the layer formation is completed and the excess gas remained is removed from the reaction chamber. In step 2-3, the surface S coated with one molecule layer of trimethyl aluminum (CH₃)₃Al is exposed to water H₂O. As a result, sequential reactions occur between trimethyl aluminum and water, producing finally aluminum oxide Al₂O₃. Compounds formed in the intermediate stages of the reaction process can include e.g. aluminum hydroxide AlOH and methane CH₄. Finally, at step 2-4, after removing the excess water and the possible other compounds, there is a continuous single molecule layer of aluminum oxide on the silver surface S.

Next, the steps of 2-1 to 2-4 are repeated in order to form another aluminum oxide molecule layer. Naturally, now the molecule layer is no more formed directly on the silver surface S but on the already formed aluminum oxide molecule layer. This way the steps of 2-1 to 2-4 are repeated until the desired thickness of the aluminum oxide is achieved.

The ALD process details are not in the core of the present invention principle and are thus not disclosed here in more detail. For a person skilled in the field of ALD, it is a routine like procedure to select the suitable equipment as well as the actual process parameters. However, one important aspect is the deposition temperature. As is described already in the above, it should be in a range allowing maintaining the silver oxidation low. One suitable range is 100-150° C.

It is important to note that the present invention is not limited to silver and aluminum oxide as the reflective metal and the protective material coating the reflective metal surface. For example, other suitable metal oxides for the ALD deposition process include: titanium oxide TiO2, tantalum oxide Ta2O5, and zirconium oxide ZrO2. In addition to the oxides, one good choice is also zinc sulfide ZnS. It is also possible to use different materials simultaneously. Further, it is possible to manufacture the passivation layer as a nanolaminate structure by using ALD with two or more materials. In manufacturing a nanolaminate structure, first one or more molecule layers of one material is deposited on the reflective metal surface. Next, one or more molecule layers of some other material is deposited on the firstly deposited molecule layers of the first material, and so on. Also more than two different materials can be used. The result of this kind of deposition is a multilayered metal oxide coating. Naturally, when depositing the first molecule layer directly on the reflective metal surface, it is important to use process parameters not significantly oxidizing the reflective metal surface.

As is clear for a person skilled in the art, the embodiments of the present invention are not limited to the examples above but they may freely vary within the scope of the claims, taking into account also the possible new possibilities opened by the advancement of the technology.

1. A glass product (1) comprising a glass substrate (2), a reflective metal layer (3) deposited on the glass substrate, and a passivation layer (4) deposited on the reflective metal layer, characterized in that the passivation layer (4) is deposited using an Atomic Layer Deposition (ALD) process.

2. A glass product (1) according to claim 1, characterized in that the passivation layer (4) is deposited directly on the reflective metal layer.

3. A glass product (1) according to claim 1 or 2, characterized in that the reflective metal layer (3) comprises silver.

4. A glass product (1) according to any of claims 1 to 3, characterized in that the passivation layer comprises (4) metal oxide.

5. A glass product (1) according to claim 4, characterized in that the passivation layer (4) comprises oxide of at least one of the following materials: Al, Ti, Zr, Nb, Zn, Si, Ta, Hf.

6. A glass product (1) according to any of claims 1 to 3, characterized in that the passivation layer comprises zinc sulfide ZnS.

7. A glass product (1) according to any of claims 1 to 6, characterized in that the total thickness of the passivation material coating the reflective metal layer (3) is less than about 200 nm, more preferably less than about 100 nm, most preferably less than about 50 nm.

8. A glass product (1) according to any of claims 1 to 7, characterized in that the glass product (1) is a flat glass product for a low emissivity window.

9. A glass product (1) according to any of claims 1 to 7, characterized in that the glass product (1) is a mirror.

10. A glass product (1) according to any of claims 1 to 7, characterized in that the glass product (1) is an optical component, e.g. a lens, for an optical system.

11. A method for manufacturing a glass product (1), the method comprising depositing a reflective metal layer (3) on a glass substrate (2), and depositing a passivation layer (4) on the reflective metal layer, characterized in that the passivation layer (4) is deposited using an atomic layer deposition (ALD) process.

12. A method according to claim 11, characterized in that the passivation layer (4) is deposited directly on the reflective metal layer (3).

13. A method according to claim 11 or 12, characterized in that the passivation layer (4) deposition comprises depositing metal oxide, and the metal oxide is deposited in a temperature in the range of 30 to 400° C., more preferably 80 to 300° C., most preferably 100 to 150° C.

14. A method according to any of claim 11 or 13, characterized in that the passivation layer (4) deposition comprises depositing metal oxide, and water H₂O is used in the ALD process as an oxygen source for the metal oxide.

15. A method according to claim 11 or 12, characterized in that the passivation layer (4) deposition comprises depositing zinc sulfide ZnS.
